(19) United States
(12) Patent Application Publication
(10) Pub. No.: US 2025/0183484 A1
(43) Pub. Date: Jun. 5, 2025

(54) BIPOLAR BATTERY STACK AND METHOD FOR PRODUCING SAME

(71) Applicant: Michael Roscher, Chemnitz (DE)

(72) Inventor: Michael Roscher, Chemnitz (DE)

(21) Appl. No.: 18/726,590

(22) PCT Filed: Jan. 7, 2022
(86) PCT No.: PCT/EP2022/050256

§ 371 Date: Jul. 3, 2024

(51) Int. Cl. H01M 50/46; H01M 4/02; H01M 10/04

(52) U.S. Cl. CPC H01M 50/461; H01M 10/0468; H01M 2004/029

(57) ABSTRACT

A method of manufacturing a bipolar battery stack (10) provides a first bipolar electrode (12) with an electrically conductive carrier foil (121) and a central region (124) coated on both sides with electrode material. A carrier foil edge (125) completely surrounds the central region (124) and is free of electrode material. A first sealing bead (201) is on the carrier foil edge region (125) to surround the carrier foil central region (124). An electrically insulating, ion-permeable, planar separator (18) is placed on the first sealing bead (201) laterally beyond the carrier foil central region (124). A second sealing bead (202) is applied to the edge region of the separator (18) beyond the carrier foil central region (124) to form a ring encircling the carrier foil central region (124), and another one is placed on the second sealing bead (202). The method repeats these steps a predetermined number of times.

### FIELD OF THE INVENTION

The invention relates to a method of manufacturing a bipolar battery stack, comprising the steps of:
a) providing a first bipolar electrode, comprising an electrically conductive carrier foil with a carrier foil central region coated on both sides with electrode material and a carrier foil edge region which completely surrounds the carrier foil central region and is free of electrode material,
b) applying a first sealing bead of an extrudable sealing material to the carrier foil edge region in the form of a ring encircling the carrier foil central region,
c) placing, onto said first sealing bead, an electrically insulating, ion-permeable, planar separator, which projects completely beyond the carrier foil central region in a lateral direction,
d) applying, to an edge region of the separator projecting beyond the carrier foil central region, a second sealing bead of an extrudable sealing material in the form of a ring encircling the carrier foil central region,
e) placing, by its carrier foil edge region, a further, equally constructed and aligned bipolar electrode onto said second sealing bead, and
f) repeating steps b to e until a predetermined number of such bipolar electrodes stacked in said manner is reached.

The invention further relates to a bipolar battery stack comprising
a plurality of bipolar electrodes stacked in a stacking direction, each comprising an electrically conductive carrier foil with a carrier foil central region coated on both sides with electrode material and a carrier foil edge region which completely surrounds the carrier foil central region and is free of electrode material, an interspace filled with an electrolyte being located between every two adjacent bipolar electrodes,
a plurality of electrically insulating, ion-permeable, flat separators corresponding to the number of interspaces, which separators are arranged in said interspaces and project, completely beyond the carrier foil central regions in a lateral direction, and
a sealing wall made of a sealing material which completely seals the interspaces in the lateral direction and in which the carrier foil edge regions and the edges of the separators are completely embedded.

### Prior Art

A generic bipolar battery stack and a method for its manufacture are known from DE 10 2018 201 693 A1.

In the context of the increasing electrification of motor vehicles, traction batteries with high power density are becoming increasingly important. Compact high-performance batteries are also in demand in other areas of technology. The concept of the so-called stack battery, also known as a bipolar battery stack, has proved particularly successful here. It allows a significantly increased power density compared to conventional batteries, which are currently still predominantly used. A stack battery comprises a stack of bipolar electrodes. A bipolar electrode is an electrically conductive, often foil-like carrier layer that is coated on both sides with an active material, which forms the electrodes within the battery, i.e. the anode or cathode of neighboring cells. The active materials used for the anode on the one hand and the cathode on the other are different, depending on the specific battery type selected, but are referred to here collectively as the electrode material. Such bipolar electrodes are stacked in such a way that one anode and one cathode face each other across an interspace. An electrically insulating, ion-permeable separator, often in the form of a ceramic fleece or an ion-permeable foil, is arranged in the interspace between the electrodes, which reliably prevents direct contact between the electrodes. In the end product, the interspace is filled with an electrolyte which, together with the adjacent anode and cathode, forms a functional cell of the stacked battery, wherein the stacked battery as a whole consists of a large number of such cells connected in series with each other. The specific choice of material for the electrolyte material, like the electrode material, depends on the battery type in question.

The above-mentioned generic publication describes in detail a method for assembling such a bipolar battery stack. Starting from a housing base, a monopolar electrode, i.e. a carrier foil coated on one side only with an electrode material, is first applied. A sealing edge in the form of a bead made of an extrudable, e.g. paste-like, gel-like or viscous, sealing material is then applied around the central region of the carrier foil, i.e. around the region covered with the electrode material. The term “sealing bead” is used for this purpose in the present description. The sealing bead is applied in particular in the immediate vicinity of the outer edge of the carrier foil. The sealing bead is slightly higher than the electrode material coating. A separator is then applied in the known process. The separator is dimensioned in such a way that it completely overlaps the central region of the carrier foil, i.e. the region coated with electrode material, laterally, but not the sealing bead. Instead, its edge rests on the sealing bead and can easily be pressed into the more or less soft sealing material. Particularly in the case of a fleece-like separator, the sealing compound penetrates the pores of the separator fleece. In particular, the known method provides for the use of a UV-curing sealing material, which is irradiated with UV light after the separator has been applied and thus cured. The separator is also fixed in this way. The next step is to apply a second sealing bead in the stacking direction exactly over the first sealing bead and cure it using UV radiation. The second sealing bead then forms the cured sealing edge of a trough with the area of the central region of the carrier foil and a depth that is slightly greater than the height of the electrode material coating of a bipolar electrode. In the next step, such a bipolar electrode is placed on said sealing edge in such a way that the coating on its underside comes to rest in said trough. A further, first sealing bead is then applied in the area of the carrier foil edge region of the bipolar electrode exactly over the already cured sealing bead pair. By placing another separator and another, second sealing bead on the separator, the process continues in the manner described until a bipolar electrode stack of the desired height has been built up. The aforementioned publication also describes the arrangement of an electrolyte in the interspace between two opposing electrode material coatings of adjacent bipolar electrodes, although this aspect is not relevant to the present invention. In any case, the built-up stack is pressurized at a given time in the direction of the stack or in the opposite direction in order to press all components together. This leads to a compaction of the entire structure and in particular to an improvement in the contacting of electrolyte and electrode material, which leads to an increase in efficiency of the resulting battery.

A major disadvantage of this known process is its lengthiness, which is due in particular to the two curing steps per battery cell. Attempts to carry out the curing only after the target stack height has been reached or at least to cure both sealing beads of a battery cell together have failed. The inventor has identified short circuits between the carrier foils of neighboring bipolar electrodes as the reason for this. Obviously, the uncured sealing material is not suitable for reliably keeping the carrier foil edge regions at a distance—not even temporarily. Only by curing the first sealing bead a sufficiently stable foundation is created on which the second sealing bead can be placed, wherein this must also be cured before the next bipolar electrode can be placed. Otherwise, the edges of the carrier foil would be distorted within the not yet cured sealing material, which would then lead to short circuits between neighboring battery cells.

### Object of the Invention

It is the object of the present invention to further develop the generic manufacturing process in such a way that a faster and thus more economical assembly of bipolar battery stacks is made possible while avoiding short circuits between individual battery cells, or to provide more economical bipolar battery stacks manufactured in this way.

### Description of the Invention

In the context of a manufacturing process, this task is solved in conjunction with the features of the generic term of claim 1 in that each separator, when it is placed onto the respectively assigned first sealing bead, projects, along its entire circumference, laterally beyond the carrier foil edge region of the bipolar electrode immediately adjacent to it.

In the context of a resulting bipolar battery stack, the problem is solved in conjunction with the features of the generic term of claim 7 in that the carrier foil edge region of no bipolar electrode projects, in the lateral direction, beyond the separators immediately adjacent to it.

Preferred embodiments are the subject of the dependent claims.

The central idea of the invention is to make the separator larger in area than the bipolar electrodes. In particular, when the separator is placed on the first sealing bead, it should protrude laterally, i.e. on each side, over the entire length of the bead and the underlying carrier foil. Any warping of the carrier foil edge region in the (as yet) uncured sealing material is then limited at the latest by abutting against the separator. The same applies to any warping of the carrier foil of the next bipolar electrode to be placed on the separator. Even if pressure is applied in the stacking direction to improve contact between the electrolyte and electrode material, the protruding separator blocks direct contact between the carrier foils of adjacent bipolar electrodes and thus reliably prevents the formation of a short circuit. The relative dimensioning of the separator surface to the carrier foil surface should be designed in such a way that even if the (often also flexible) separator is warped in the final stack, the separator still protrudes beyond the edge of the carrier foil or at least remains flush between the edge of the separator and the edge of the carrier foil.

When selecting curable sealing materials, the invention makes it possible to perform the curing only at the end of the stack assembly or at least in only one curing step for each individual battery cell. This means a significant acceleration of the stack assembly. However, the invention also makes it possible to use permanently elastic sealing materials instead of curable materials, such as butyl rubber, which is known, for example, from the liquid- and gas-tight sealing of insulating glass panes and whose use is also of great advantage in the field of high-performance batteries.

The skilled person will understand that, in particular, the sequence of steps c) and d) is interchangeable. In this respect, the structure of claim 1 does not constitute a limitation of the method in terms of time, i.e. in relation to the sequence of the individual method steps. Thus, within the scope of the invention, it is readily possible to provide the separator to be fitted with the second sealing bead already outside the stack and then to fit the combination of separator and second sealing bead onto the first sealing bead.

Conversely, it is also possible to place the separator alone on the first sealing bead and then apply the second sealing bead. In practice, the former variant has proven to be particularly advantageous.

The skilled person will also understand that the sealing beads do not necessarily have to form closed rings. It is also conceivable to apply separate portions of sealing compound in the form of rings, which later run into each other and merge, particularly when pressure is applied in the stacking direction or in the opposite direction.

A process variant in which every second sealing bead is applied laterally offset to the outside of the corresponding first sealing bead has proven to be particularly favorable. This means that the two sealing beads of a battery cell do not lie vertically on top of each other in the stacking direction. If the separators are made of a flexible material, the offset arrangement makes it possible for this separator material—at least under the effect of pressure applied in the stacking direction—to undulate between the sealing beads adjacent to the respective separator in accordance with their contours. In other words, the two laterally offset sealing beads exert a shearing force on the edge region of the separator, causing it to undulate and thus structurally stabilize, as is known from stiffening beads in sheet metal or from corrugated sheet metal or corrugated cardboard. The separator—at least in its edge region—thus becomes an active spacer between the neighboring bipolar electrodes, which can even lie directly against the carrier foils at the peaks of its undulation. Particularly in the case of porous separator materials that can be penetrated by the sealing material, such as ceramic nonwovens, this creates a very stable structure that can be further stabilized by appropriate curing if curable sealing materials are selected. However, it is of course also possible to choose other separator materials, such as single or multi-layer plastic foils, etc.

When it is mentioned above that the separator undulates according to the contours of the sealing beads, this does not mean that these are rigid compared to the separator material. Particularly when pressure is applied in the stacking direction, the (still) flexible sealing beads also deform and change their contour. The sealing beads and separator thus nestle against each other. The exact shape of the separator and/or the edge regions of the carrier foil in the finished product can therefore not be predicted down to the last detail. However, this is not even necessary due to the present invention, because the protrusion of the separator according to the invention means that contact between adjacent carrier foils and thus a short circuit is ruled out in any case.

The deformation of the sealing beads can be supported by heating the stacked structure after step f). Typical heating temperatures are between 50° C. and 180° C.

As with the known bipolar battery stacks, the edges of the carrier foils and separators should be completely embedded in the sealing wall of the finished product. This means that the stack should have a uniform wall surface on the outside so that the components essential for generating electrical energy have no contact with the environment. Since, as explained above, the exact position of the separator and carrier foil edges cannot be predicted in detail and it is therefore also not guaranteed under all circumstances that the first and second sealing beads are sufficient to ensure such complete embedding, a further development of the invention provides that, between steps b) and e), a further sealing bead in the form of a preferably closed ring surrounding the second sealing bead is applied to the edge region of each separator projecting beyond the carrier foil central region. In other words, a further sealing bead is applied to the very outer edge of the separator, which extends between adjacent separators and is laterally positioned and dimensioned in such a way that all outer edges of separators and carrier foils are embedded in the sealing material. If necessary, these outer sealing beads can be spread to form a smooth outer wall in a final process step.

Further details and advantages of the invention can be seen from the following special description and the drawings.

### BRIEF DESCRIPTION OF THE DRAWINGS

There show:

FIG. 1: a schematic sectional view of the lower part of a bipolar battery stack according to the invention,

FIG. 2: a schematic side view and a top view of a bipolar electrode and

FIG. 3: three phases of a preferred embodiment of the manufacturing process according to the invention.

### DESCRIPTION OF PREFERRED EMBODIMENTS

Identical reference signs in the figures indicate identical or analogous elements.

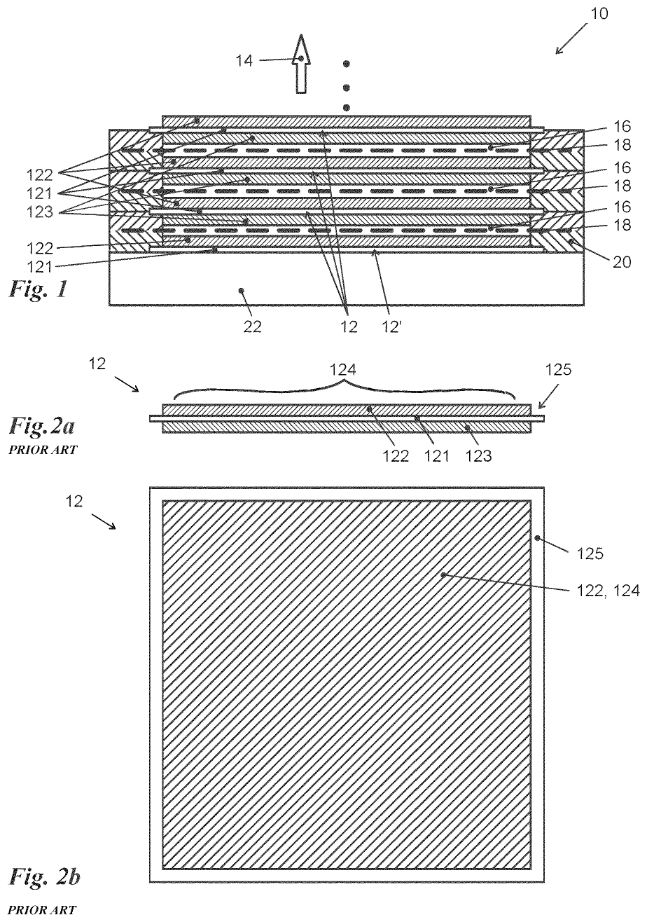

FIG. 1 shows a highly schematized cross-section through the lower region of a bipolar battery stack 10 according to the invention, which essentially comprises a plurality of bipolar electrodes 12 stacked on top of one another, as shown separately in FIG. 2 in side view (FIG. 2a) and in top view (FIG. 2b). As is generally known from the prior art, each bipolar electrode comprises an electrically conductive carrier foil 121 which is coated on both sides with an electrode material for forming electrodes, namely an anode 122 and a cathode 123. However, the coating with the electrode material extends only over a carrier foil central region 124, whereas a carrier foil edge region 125 completely surrounding the carrier foil central region 124 remains free of a coating with electrode material.

The bipolar battery stack 10 of FIG. 1 comprises several such bipolar electrodes 12, which are stacked on top of each other in a stacking direction 14. They are each oriented in the same way, so that the anode 122 of a bipolar electrode 12 faces the cathode 123 of an immediately adjacent bipolar electrode 12 across an interspace 16. The interspace 16 is filled with an electrolyte not shown separately. In this way, the anode 122 and the cathode 123 of adjacent bipolar electrodes 12 together with the electrolyte between them form a single battery cell, of which the bipolar battery stack 12 contains a number, which are connected in series with one another via their respective electrically conductive carrier foils 121.

In order to reliably prevent direct contact between the anode 122 and cathode 123 of an individual battery cell, a separator 18 runs through each interspace 16. This is electrically insulating and ion-conducting. It is preferably formed as a ceramic fleece or a single or multi-layer, ion-permeable plastic foil. As can be clearly seen in the sectional view of FIG. 1, the separator protrudes laterally, i.e. in reality completely, beyond the carrier foil 121 of the respective adjacent bipolar electrodes 12.

FIG. 1 clearly shows that the battery cells are laterally, i.e. in reality completely, surrounded by a sealing wall 20. The sealing wall 20, which is made of a sealing material, serves to seal the battery cells from the environment in a gas- and liquid-tight manner. It can be clearly seen that both the outer edges of the carrier foils 121, in particular their entire carrier foil edge regions 125, and the edges of the separators 18 are embedded in said sealing wall 20.

In the embodiment shown, the lower electrode of the lowest battery cell is not a bipolar but a monopolar electrode 12′. In the embodiment shown, this consists only of the carrier foil 121 and a coating on one side to form an anode 122. The bipolar battery stack 12 is bounded at the bottom by a housing base 22, which also contains the electrical leads for contacting the battery cells in a manner not shown.

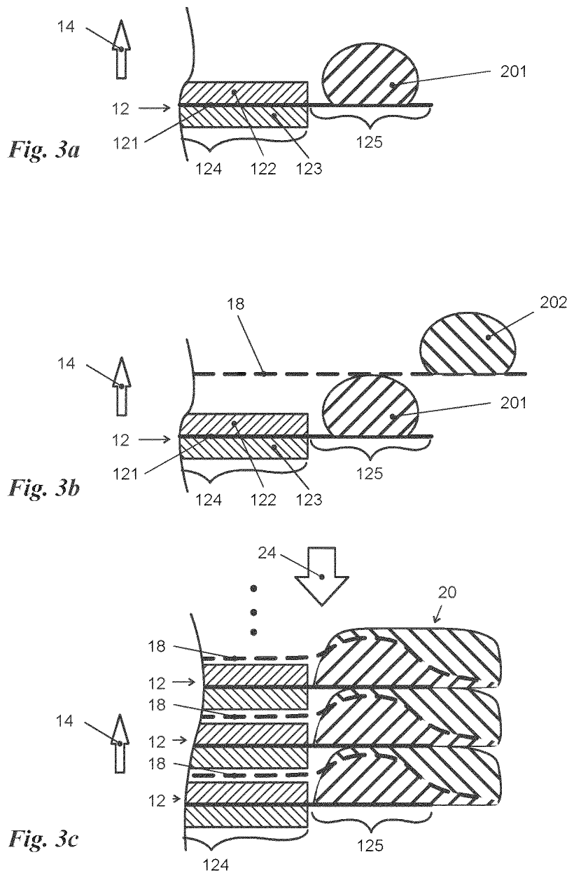

FIG. 3 shows three phases of a particularly preferred embodiment of a process for producing a bipolar battery stack 10, similar to that shown in FIG. 1, also in highly schematized form. The figures show only the relevant sections of the respective bipolar battery stack precursor. The skilled person will be able to add the other elements in his mind without further ado. FIG. 3a shows an edge section of a bipolar electrode 12, comprising the carrier foil 121, which is coated in its carrier foil central region 124 with the electrode material for an anode 122 and a cathode 123. A first sealing bead 201 is applied to the protruding carrier foil edge region 125. This forms a preferably closed ring which runs around the entire carrier foil central region 124. The sealing material of which said sealing bead is made can be a permanently elastic paste, such as butyl rubber, or a curable material, for example on an epoxy basis. Depending on the specific chemistry, it may be a light-curing material or a material that cures as a single or multi-component adhesive.

In any case, before any curing, a separator 18 is placed on the first sealing bead 201 in the next step, as shown in FIG. 3b. Its edge region clearly protrudes beyond the edge of the carrier foil 121. In the embodiment shown, a second sealing bead 202 is applied to this protruding region of the separator 18. This surrounds the entire separator 18 in the form of a preferably closed ring. As can be clearly seen in FIG. 3b, the ring of sealing material formed by the second sealing bead 202 is slightly offset outwards in relation to the ring of sealing material formed by the first sealing bead 201. It is also conceivable that the steps could be performed in the reverse order: The second sealing bead 202 can also be formed only after the separator 18 has been placed on the first sealing bead 201. The sealing materials of the sealing beads 201, 202 can be identical or different from one another.

In this way, a stack is built up which, in the next step shown in FIG. 3c, is subjected to mechanical pressure 24 in the stacking direction 14 (or in the opposite direction). This leads to the sealing beads 201, 202 being pressed together to form a uniform, closed sealing wall 20. Depending on the relative material rigidity of the sealing beads 201, 202 on the one hand and the separator 20 or the carrier foil edge regions 125 on the other hand, this may result in the foil materials undulating. In the embodiment shown, undulation of the separator 18 is shown. However, due to its significant protrusion over the carrier foils 121, it is ensured that even under unfavorable process conditions, adjacent carrier foils 121 do not touch each other directly and thus form an internal short circuit. Rather, the separator 18 also acts as a reliable spacer in the corrugated state, which reliably prevents short circuits in any case.

Of course, the embodiments discussed in the specific description and shown in the figures are only illustrative examples of the present invention. In the light of the present disclosure, the person skilled in the art is provided with a wide range of possible variations. In particular, with regard to the specific battery chemistry and/or the chemistry of the sealing material of the sealing beads 201, 202, which may be curable, the person skilled in the art has the option of choosing from all known variants and variants which may still be developed. The skilled person is also largely free to choose the electrolyte between the bipolar electrodes 12. In particular, if a liquid electrolyte is selected at least at the time of filling, the application of the sealing beads 201, 202 can be combined with the insertion of cannulae passing through the sealing wall that is subsequently formed, through which the liquid electrolyte is filled into the spaces 16 between the bipolar electrodes 12.

### LIST OF REFERENCE SYMBOLS

10 bipolar battery stack
12 bipolar electrode
121 carrier foil
122 anode
123 cathode
124 carrier foil central region
125 carrier foil edge region
12′ monopolar electrode
14 stacking direction
16-interspace
18 separator
20 sealing wall
201 first sealing bead
202 second sealing bead
22 housing base
24 pressure

1. A method of manufacturing a bipolar battery stack (10) comprising:
a) providing a first bipolar electrode (12), comprising an electrically conductive carrier foil (121) with a carrier foil central region (124) coated on both sides with electrode material and a carrier foil edge region (125) that completely surrounds the carrier foil central region (124) and is free of electrode material,
b) applying a first sealing bead (201) of an extrudable sealing material to the carrier foil edge region (125) in the form of a ring encircling the carrier foil central region (124),
c) placing, onto said first sealing bead (201), an electrically insulating, ion-permeable, planar separator (18); which that projects completely beyond the carrier foil central region (124) in a lateral direction,
d) applying, to an edge region of the separator (18) projecting beyond the carrier foil central region (124), a second sealing bead (202) of an extrudable sealing material in the form of a ring encircling the carrier foil central region (124),
e) placing, by its carrier foil edge region (125), a further, equally constructed and aligned bipolar electrode (12) onto said second sealing bead (202), and
f) repeating steps b to e until a predetermined number of such bipolar electrodes (12) stacked in said manner is reached,
wherein each separator (18), when placed onto the respectively assigned first sealing bead (201), projects, along an entire circumference thereof, laterally beyond the carrier foil edge region (125) of the bipolar electrode (12) immediately adjacent to the respective bipolar electrode (12), and
each second sealing bead (202) is applied laterally outwardly offset from the respective corresponding first sealing bead (201).

2. The method of claim 1, wherein the separators (18) consist of a flexible material that—at least under an influence of a pressure (24) applied in the stacking direction (14) or in the opposite direction thereto—undulates between the sealing beads (201, 202) adjacent to the respective separator (18) in accordance with their contours.

3. The method of claim 2, wherein, after step f, a pressure (24) acting in the stacking direction (14) or in a direction opposite the stacking direction (14) is exerted on a stacked structure produced by the stacking.

4. The method of claim 3, wherein the stacked structure is heated to a temperature between 50° C. and 180° C. after step f.

5. The method of claim 4, wherein between steps b and e, a further sealing bead in the form of a ring surrounding the second sealing bead (202) is applied to the edge region of each separator (18) projecting beyond the carrier foil central region (124).

6-9. (canceled)

10. The method of claim 1, wherein, after step f, a pressure (24) acting in the stacking direction (14) or in a direction opposite the stacking direction (14) is exerted on a stacked structure produced by the stacking.

11. The method of claim 1, wherein the stacked structure is heated to a temperature between 50° C. and 180° C. after step f.

12. The method of claim 1, wherein between steps b and e, a further sealing bead in the form of a ring surrounding the second sealing bead (202) is applied to the edge region of each separator (18) projecting beyond the carrier foil central region (124).
